(19) United States
(12) Patent Application Publication
(10) Pub. No.: US 2012/0137984 A1
(43) Pub. Date: Jun. 7, 2012

(54) GROOM TUNNEL

(76) Inventor: David Haaf, San Rafael, CA (US)

(21) Appl. No.: 12/958,965

(22) Filed: Dec. 2, 2010

(51) Int. Cl. A01K 13/00

(52) U.S. Cl. 119/601; 119/622

(57) ABSTRACT

A cat grooming device and method for using it. The device includes a cylinder having a shell, the shell having open ends, an exterior surface and interior surface. The interior surface is provided with a lining capable of grooming a cat passing within the cylinder. Ideally, the lining is composed of unwoven polyester fibers or directional microfibers.

### TECHNICAL FIELD

The present invention involves a device for grooming a pet cat in the form of a cylinder having open ends. The cat is urged within the cylinder which is lined with a material capable of grooming a cat passing therethrough.

### BACKGROUND OF THE INVENTION

It is quite important for the health and well being of a domestic cat to provide proper grooming. Oftentimes, cats try to clean themselves spending a good deal of time licking their fur and paws. However, external grooming is also highly recommended as grooming accomplishes much more than providing a healthy coat. It also stimulates circulation, removes loose hair and helps prevent matting.

Cats also require a private space for seclusion and resting. The present invention recognizes a synergy involved in making a secluded space available while lining the space with an appropriate material capable of grooming.

It is thus an object of the present invention to provide a cat grooming device and method which cats will find enjoyable and thus employ even without the involvement of their owners.

These and further objects will be more readily appreciated when considering the following disclosure and appended claims.

### SUMMARY OF THE INVENTION

A cat grooming device and method for using it. The device includes a cylinder having a shell, the shell having open ends, an exterior surface and interior surface. The interior surface is provided with a lining capable of grooming a cat passing within the cylinder. Ideally, the lining is composed of unwoven polyester fibers or directional microfibers.

### BRIEF DESCRIPTION OF THE FIGURES

FIG. 1 is a perspective view of the cat grooming device of the present invention.

FIG. 2A is a cross sectional view taken along line 2-2 of FIG. 1.

FIG. 2B is a cross sectional view of a cat grooming device of the present invention illustrating an alternative grooming material to that illustrated in FIG. 2A.

FIG. 3 is a font perspective view of a further embodiment of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

As noted, the present invention recognizes the synergy in exposing a cat to grooming material within a space, in this particular instance, a cylinder, which a domestic cat would naturally seek out as providing seclusion for rest and relaxation. Merely by passing within and through such device, the cat will be groomed and loose hair, dander and the like which will remain within the device removable at a later time by vacuuming or by employing other common cleaning expedients.

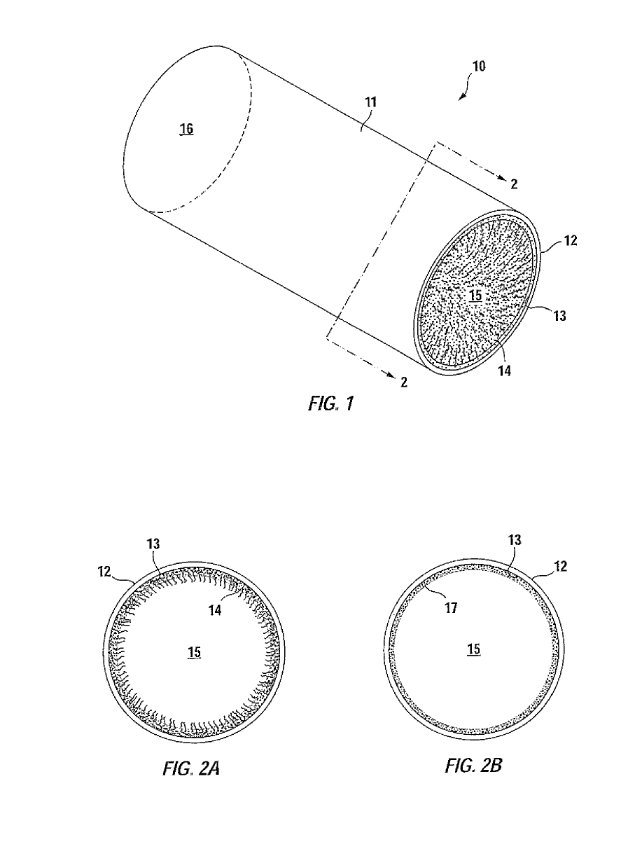

With the above in mind, reference is made to FIGS. 1 and 2A depicting cat grooming device 10 in the form of cylinder 11 having a shell with exterior surface 12 and interior surface 13 and open ends 15 and 16. Interior surface 13 is provided with a lining capable of grooming a cat passing within the cylinder.

An ideal material for use in the present invention is a lining of unwoven fibers 14 such as unwoven polyester fibers an example of which are disclosed in U.S. Pat. No. 5,363,804, the disclosure which is incorporated by reference herein. It is noted that such fibers are naturally electrostatic (cationic) and, thus, cat hair and dander tends to cling to this material. As a consequence, as a cat is urged to enter one of openings 15 or 16 and pass through cylinder 11, fibers 14 will tend to groom the cat because such fibers extend randomly within the interior space of cylinder 11 and, as noted, because of its electrostatic nature, fibers 14 tend to pick up and retain cat fur and dander resulting from the grooming process.

As an alternative to the use of unwoven fibers 14, reference is made to FIG. 2B. In this instance, cylinder 11 having exterior surface 12 and interior surface 13 is provided with liner 17 in the form of directional microfibers. These microfibers are synthetic measuring generally less than one denier. The most common type of microfibers are made from polyesters, polyamides, such as nylon, kevlar, nomex and trogamide and/or conjugation of polyester and polyamide. A cat, residing or rolling over within cylinder 11 will appreciate the smooth supple feel of the microfibers in a first direction and a rougher resistant feel in the opposite direction. The later attribute stimulates grooming while the microfiber can capture dander and loose hair resulting from the grooming exercise.

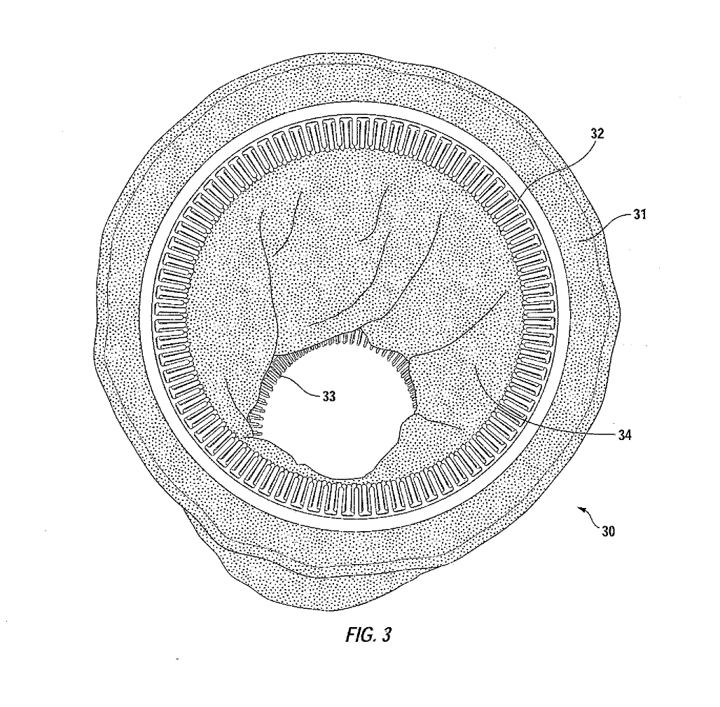

Reference is next made to FIG. 3 depicting cat grooming device 30 having a shell 31 defining a cylinder having open ends. In this example, grooming device 30 is provided with liner 34 such as a layer of directional microfiber. Cat grooming device 30 is also provided with several rows of flexible nodules 32 and 33 situated at the openings of grooming device 30. These nodules can be of a constant size, shape and diameter or be of various lengths. They are ideally composed of thermoplastic resin and are of a sufficient length to provide quite giving flexible shafts which act as further grooming expedients which cats generally find stimulating and inviting. It has been found that as a cat enters grooming device 30, nodules in regions 32 and 33 will interact with the cat stimulating the removal of loose fur and dander. This would enhance the grooming action of either the unwoven fiber or directional microfibers and, when the lining is electrostatic, the loose fur and dander released from the cat will tend to be drawn to and adhere to the interior cylindrical shell 31.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like.

Therefore, the above description and illustration should not be considered as limiting the scope of the invention, which is defined by the appended claims.

What is claimed is:

1. A cat grooming device comprising a cylinder having a shell, said shell having open ends, an exterior surface and interior surface, said interior surface having a lining capable of grooming a cat passing within said cylinder.

2. The cat grooming device of claim 1 wherein said lining comprises unwoven fibers.

3. The cat grooming device of claim 1 wherein said unwoven fibers are naturally electrostatic.

4. The cat grooming device of claim 2 wherein said lining comprises unwoven polyester fibers.

5. The cat grooming device of claim 1 wherein said liner comprises directional microfibers.

6. The cat grooming device of claim 1 further comprising rows of flexible nodules located at at least one of said open ends and extending within said interior surface of said shell.

7. The cat grooming device of claim 6 wherein rows of said flexible nodules are located at both of said open ends of said shell.

8. A method of grooming a pet cat, said method comprising providing a grooming device, said grooming device comprising a cylinder having a shell, said shell having open ends, said cat being urged to enter said shell at one of said open ends and to exit said shell at another of said open ends, said shell having an exterior surface and interior surface, said interior surface having a lining capable of grooming a cat passing within said cylinder.

9. The method of claim 8 wherein said lining comprises unwoven fibers.

10. The method of claim 9 wherein said unwoven fibers are naturally electrostatic.

11. The method of claim 9 wherein said lining comprises unwoven polyester fibers.

12. The method of claim 8 wherein said lining comprises directional microfibers.
